(19) United States
(12) Patent Application Publication
(10) Pub. No.: US 2017/0134688 A1
(43) Pub. Date: May 11, 2017

(54) METHOD FOR PROVIDING CONTENT AND ELECTRONIC DEVICE SUPPORTING THE SAME

(71) Applicant: Samsung Electronics Co., Ltd., Gyeonggi-do (KR)

(72) Inventors: Suha YOON, Seoul (KR); Euichang Jung, Seoul (KR); Jae-Woong Chun, Gyeonggi-do (KR)

(73) Assignee: Samsung Electronics Co., Ltd.

(21) Appl. No.: 15/348,658

(22) Filed: Nov. 10, 2016

(30) Foreign Application Priority Data
Nov. 10, 2015 (KR) 10-2015-0157548

(51) Int. Cl. H04N 5/77; G06F 17/30; H04N 5/232; G06F 3/16; H04N 1/21

(52) U.S. Cl. CPC H04N 5/772; G06F 3/165; G06F 3/16; H04N 1/2112; H04N 5/23293; G06F 17/30026; H04N 2201/3264; H04N 2101/00

(57) ABSTRACT

A method for use with an electronic device having a memory and a processor, and an electronic device are provided. The method includes acquiring at least one image through a camera operatively coupled to the electronic device, acquiring a first sound and a second sound, which are sensed when acquiring the at least one image, through a microphone operatively coupled to the electronic device, generating first sound information corresponding to the first sound and second sound information corresponding to the second sound using the processor, and associating the at least one image with the first sound information and the second sound information and storing the at least one image in the memory.

### PRIORITY

This application claims priority under 35 U.S.C. §119(a) to Korean Patent Application Serial No. 10-2015-0157548, which was filed in the Korean Intellectual Property Office on Nov. 10, 2015, the entire disclosure of which is incorporated herein by reference.

### BACKGROUND

1. Field of the Disclosure

The present disclosure relates generally to a method for providing content, and more particularly, to a method for selectively providing content such as sound recorded at a time of photographing, music included in the recorded sound, and sound exclusive of the music included in the recorded sound, together with an image, and an electronic device supporting the same.

2. Description of the Related Art

With the advance of information telecommunication technologies, semiconductor technologies, etc., the supply and use of electronic devices (e.g., mobile terminals) are increasing rapidly. With the expansive supply of the electronic devices, the electronic devices are providing various contents to users.

For example, the electronic device can photograph a photo or moving-picture using a camera, and can display the photographed photo or moving-picture by executing a gallery application. The electronic device can also provide a video call, and can record a voice, etc. that are inputted through a microphone, etc., and output the recorded voice through a speaker by executing a recorder application (or voice memo application). The electronic device can provide a user with content such as an image, a voice, etc. that are acquired through the camera, the microphone, etc., and also transmit the acquired content to electronic devices of user or electronic devices of other users by executing a share application. Through this, the electronic device can share content between the users.

In recent years, electronic devices are providing a function of combining and storing information on a photo photographed with a camera and sound information recorded at the photographing and concurrently outputting the photographed photo and the recorded sound information (hereinafter, referred to as a ‘sound and shot function’).

A conventional electronic device can, for example, store sound information recorded during image acquisition together with an image, by using a video call function, a moving-picture photographing function, a sound and shot function, etc. A sound recorded during the image acquisition can be sound that acts on users as noises or that the users desire. Also, in instance where the sound information recorded during the image acquisition includes music information, the user may desire to listen to only music exclusive of noises among recorded sound.

Conventional electronic device merely provide a function of outputting (or playing) the image stored at a time of photographing and the sound information recorded at photographing, irrespective of a user's needs.

### SUMMARY

An aspect of the present disclosure provides a method for providing content and an electronic device supporting the same, for selectively providing content such as sound recorded at a time of photographing, music included in the recorded sound, and sound exclusive of the music included in the recorded sound, together with an image.

In accordance with an aspect of the present disclosure, there is provided a method for use with an electronic device comprising a memory and a processor. The method includes acquiring at least one image through a camera operatively coupled to the electronic device, acquiring a first sound and a second sound, which are sensed when acquiring the at least one image, through a microphone operatively coupled to the electronic device, generating first sound information corresponding to the first sound and second sound information corresponding to the second sound using the processor, and associating the at least one image with the first sound information and the second sound information and storing the at least one image in the memory.

In accordance with an aspect of the present disclosure, there is provided a method for use with an electronic device comprising a memory for storing first sound information corresponding to a first sound and second sound information corresponding to a second sound. The method includes selecting at least one image, the first sound and the second sound being acquired at the same time as the at least one image is selected, displaying the at least one image through a display operatively coupled to the electronic device, and while the at least one image is being displayed, playing the first sound using a first attribute and the second sound using a second attribute, independently of each other, through a speaker operatively coupled to the electronic device.

In accordance with an aspect of the present disclosure, there is provided an electronic device which includes a camera operatively coupled with the electronic device, a microphone operatively coupled with the electronic device, a memory, a communication circuit, and a processor configured to acquire at least one image s through the camera, acquire a first sound and a second sound, which are sensed when the at least one image is acquired, through the microphone, generate first sound information corresponding to the first sound and second sound information corresponding to the second sound, and associate the at least one image with the first sound information and the second sound information and store the at least one image in the memory.

In accordance with an aspect of the present disclosure, there is provided a non-transitory storage medium storing instructions thereon that are set to allow at least one processor to perform a method for use with an electronic device. The method includes acquiring at least one image a camera operatively coupled with the electronic device comprising a memory and a processor, acquiring a first sound and a second sound, which are sensed when the at least one image is acquired, through a microphone operatively coupled with the electronic device, and using the processor to generate first sound information corresponding to the first sound and second sound information corresponding to the second sound, and associate the at least one image with the first sound information and the second sound information and store the at least one image in the memory.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram of a network including an electronic device, according to an embodiment of the present disclosure;

FIG. 2 is a block diagram of an electronic device, according to an embodiment of the present disclosure;

FIG. 3 is a block diagram of a program module, according to an embodiment of the present disclosure;

FIG. 4 is a diagram illustrating a method for providing content, according to an embodiment of the present disclosure;

FIG. 5 is a flowchart of a method for providing content, according to an embodiment of the present disclosure;

FIGS. 6A and 6B are diagrams illustrating a method for acquiring peripheral sound information, according to an embodiment of the present disclosure;

FIG. 7 is a diagram illustrating a content acquiring and storing method according to an embodiment of the present disclosure;

FIG. 8 is a flowchart of a method for providing content, according to an embodiment of the present disclosure;

FIG. 9 is a flowchart of a method for providing content, according to an embodiment of the present disclosure;

FIG. 10 is a flowchart of a system for providing content, according to an embodiment of the present disclosure;

FIG. 11 is a flowchart of a method for providing content, according to an embodiment of the present disclosure;

FIG. 12 is a diagram illustrating a method for providing content, according to an embodiment of the present disclosure;

FIG. 13 is a diagram illustrating a method for providing content, according to an embodiment of the present disclosure;

FIG. 14 is a diagram illustrating a method for providing content, according to an embodiment of the present disclosure;

FIG. 15 is a flowchart of a content sharing method, according to an embodiment of the present disclosure;

FIG. 16 is a flowchart of a content sharing method, according to an embodiment of the present disclosure;

FIG. 17 is a flowchart of a content sharing method, according to an embodiment of the present disclosure; and

FIG. 18 is a flowchart of a content sharing method, according to an embodiment of the present disclosure.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may 20 indicate different user devices regardless of the order or importance. For example, a first element may be referred to as a second element without departing from the scope the present disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The term “module” as used herein may be defined as, for example, a unit including one of hardware, software, and firmware or two or more combinations thereof. The term “module” may be interchangeably used with, for example, the terms “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

The terms used in describing the various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

Electronic devices according to the embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to an embodiment of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™ ), electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) devices, or Internet of Things (IoT) devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. Also, the electronic devices are not limited to the above-mentioned devices, and may include new electronic devices according to the development of new technologies.

Hereinafter, the electronic devices according to various embodiments of the present disclosure will be described with reference to the accompanying drawings. The term “user” as used herein may refer to a person who uses an electronic device or may refer to a device (e.g., an artificial intelligence electronic device) which uses an electronic device.

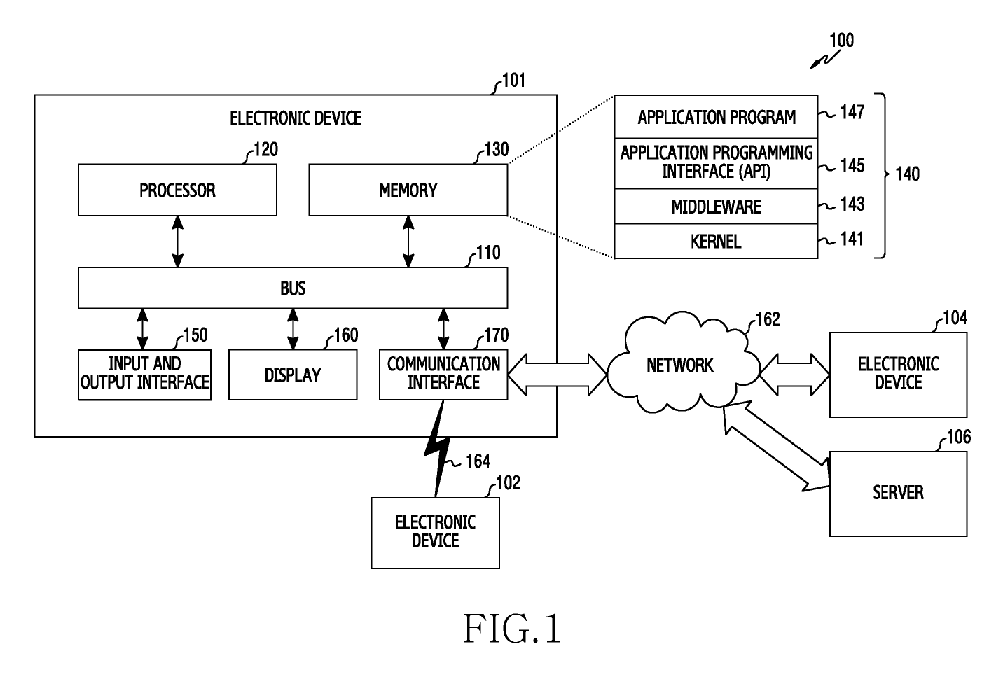

FIG. 1 is a network 100 including an electronic device 101, according to an embodiment of the present disclosure.

The electronic device 101 includes a bus 110, a processor 120, a memory 130, an input/output interface 150, a display 160, and a communication interface 170. The electronic device 101 may omit at least one of the above elements or may further include other elements.

The bus 110 may include, for example, a circuit for connecting the elements 110-170 and transferring communication (e.g., control messages and/or data) between the elements.

The processor 120 may include one or more of a central processing unit (CPU), an application processor (AP), and a communication processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. The memory 130 may store software and/or a program 140. The program 140 may include, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more operation requests received from the application program 147 according to a priority scheme. For example, the middleware 143 may give priority to use the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests according to the priority given to the at least one application program.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may function as an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a liquid crystal display (LCD), a light emitting diode (LED) display, an organic light emitting diode (OLED) display, a micro electro mechanical system (MEMS) display, or an electronic paper display. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The communication interface 170, for example, may set communication between the electronic device 101 and a first external electronic device 102, a second external electronic device 104, or a server 106. For example, the communication interface 170 may be connected to a network 162 through wireless or wired communication to communicate with the second external electronic device 104 or the server 106.

The wireless communication may use at least one of, for example, long term evolution (LTE), LTE-advance (LTE-A), code division multiple access (CDMA), wideband CDMA (WCDMA), universal mobile telecommunications system (UMTS), WiBro (Wireless Broadband), and global system for mobile communications (GSM), as a cellular communication protocol. In addition, the wireless communication may include, for example, short range communication 164. The short-range communication 164 may be performed by using at least one of, for example, Wi-Fi, bluetooth (BT), BT low energy (BLE), near field communication (NFC), and global navigation satellite system (GNSS). The GNSS may include at least one of, for example, a global positioning system (GPS), a global navigation satellite system (Glonass), a Beidou navigation satellite system (Beidou), and a European global satellite-based navigation system (Galileo), according to a use area, a bandwidth, or the like. Hereinafter, in the present disclosure, the “GPS” may be interchangeably used with the “GNSS”. The wired communication may include at least one of, for example, a universal serial bus (USB), a high definition multimedia interface (HDMI), recommended standard 232 (RS-232), and a plain old Telephone service (POTS). The network 162 may include at least one of a communication network such as a computer network (e.g., a local area network (LAN) or a wide area network (WAN)), the Internet, and a telephone network.

Each of the first and second external electronic apparatuses 102 and 104 may be of a type identical to or different from that of the electronic apparatus 101. The server 106 may include a group of one or more servers. All or some of the operations performed in the electronic device 101 may be performed in another electronic device or the electronic devices 102 and104 or the server 106. When the electronic device 101 has to perform some functions or services automatically or in response to a request, the electronic device 101 may make a request for performing at least some functions relating thereto to the electronic device 102 or 104 or the server 106 instead of performing the functions or services by itself or in addition. Another electronic apparatus may execute the requested functions or the additional functions, and may deliver a result of the execution to the electronic apparatus 101. The electronic device 101 may process the received result as it is or additionally to provide the requested functions or services. To achieve this, for example, cloud computing, distributed computing, or client-server computing technology may be used.

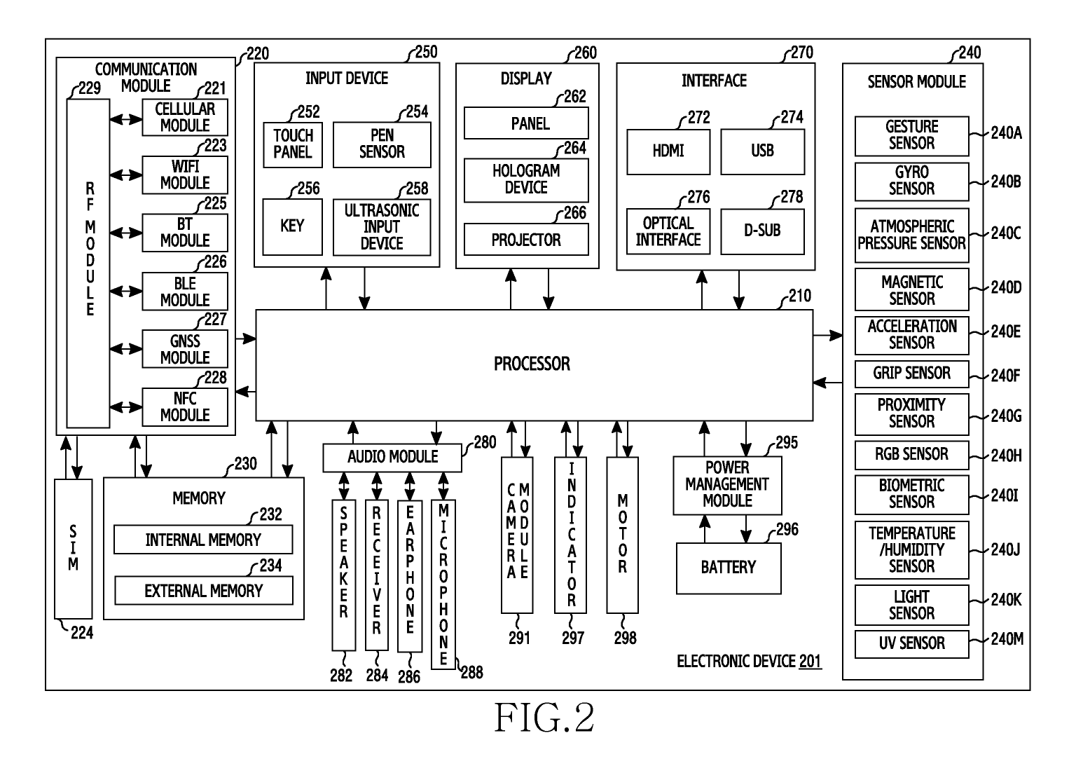

FIG. 2 is a block diagram of an electronic device 201, according to an embodiment of the present disclosure.

The electronic apparatus 201 may all or some of the components of electronic apparatus 101 of FIG. 1. The electronic device 201 includes at least one processor (e.g., Application Processor (AP)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a system on chip (SoC). The processor 210 may further include a graphic processing unit (GPU) and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may have a configuration equal or similar to that of the communication interface 170 of FIG. 1. The communication module 220 may include, for example, the cellular module 221, a Wi-Fi module 223, a BT module 225, a Bluetooth low energy module 226, a GNSS module 227 (e.g., a GPS module, a Glonass module, a Beidou module, or a Galileo module), an NFC module 228, and a radio frequency (RF) module 229.

The cellular module 221 may provide a voice call, image call, a text message service, or an Internet service through, for example, a communication network. The cellular module 221 may distinguish between and authenticate electronic devices 201 within a communication network using the SIM card 224. The cellular module 221 may perform at least some of the functions that the processor 210 may provide. The cellular module 221 may include a communication processor (CP).

Each of the Wi-Fi module 223, the BT module 225, the Bluetooth low energy module 226, the GNSS module 227, and the NFC module 228 may include, for example, a processor for processing data transmitted and received through the relevant module. At least some (e.g., two or more) of the cellular module 221, the Wi-Fi module 223, the BT module 225, the GNSS module 227, and the NFC module 228 may be included in one integrated chip (IC) or IC package.

The RF module 229 may transmit/receive, for example, a communication signal (for example, an RF signal). The RF module 229 may include, for example, a transceiver, a power amplifier module (PAM), a frequency filter, a low noise amplifier (LNA), and an antenna. At least one of the cellular module 221, the Wi-Fi module 223, the BT module 225, the Bluetooth low energy module 226, the GNSS module 227, and the NFC module 228 may transmit and receive RF signals through a separate RF module.

The SIM 224 may be an embedded SIM, and may contain unique identification information (e.g., an integrated circuit card identifier (ICCID)) or subscriber information (e.g., an international mobile subscriber identity (IMSI)).

The memory 230 may include, for example, an internal memory 232 or an external memory 234. The embedded memory 232 may include at least one of a volatile memory (for example, a dynamic random access memory (DRAM), a static RAM (SRAM), a synchronous dynamic RAM (SDRAM), and the like) and a non-volatile memory (for example, a one time programmable read only memory (OTPROM), a programmable ROM (PROM), an erasable and programmable ROM (EPROM), an electrically erasable and programmable ROM

(EEPROM), a mask ROM, a flash ROM, a flash memory (for example, a NAND flash memory or a NOR flash memory), a hard disc drive, a solid state drive (SSD), and the like).

The external memory 234 may further include a flash drive, for example, a compact flash (CF), a secure digital (SD), a micro secure digital (Micro-SD), a mini secure digital (Mini-SD), an eXtreme digital (xD), a memory stick, or the like. The external memory 234 may be functionally and/or physically connected to the electronic apparatus 201 through various interfaces.

The sensor module 240 may measure a physical quantity or detect an operation state of the electronic device 201, and may convert the measured or detected information into an electrical signal. For example, the sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red/green/blue (RGB) sensor), a bio-sensor 2401, a temperature/humidity sensor 240J, a light sensor 240K, and an ultra violet (UV) sensor 240M. Additionally or alternatively, the sensor module 240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments of the present disclosure, the electronic apparatus 201 may further include a processor configured to control the sensor module 240 as a part of or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use at least one of, for example, a capacitive type, a resistive type, an infrared type, and an ultrasonic type. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wavers generated by an input tool through a microphone 288 and identify data corresponding to the detected ultrasonic waves.

The display 260 may include a panel 262, a hologram device 264 or a projector 266. The panel 262 may include a configuration that is identical or similar to the display 160 illustrated in FIG. 1. The panel 262 may be flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, inside or outside the electronic apparatus 201. According to an embodiment, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a d-subminiature (D-sub) 278. The interface 270 may be included in, for example, the communication interface 170 illustrated in FIG. 1. Additionally or alternatively, the interface 270 may include, for example, a mobile high-definition link (MHL) interface, a SD card/multi-media card (MMC) interface, or an infrared data association (IrDA) standard interface.

The audio module 280 may bilaterally convert, for example, a sound and an electrical signal. At least some elements of the audio module 280 may be included in, for example, the input/output interface 145 illustrated in FIG. 1. The audio module 280 may process sound information which is input or output through, for example, a speaker 282, a receiver 284, earphones 286, the microphone 288 or the like.

The camera module 291 may photograph a still image and a dynamic image. The camera module 291 may include one or more image sensors (for example, a front sensor or a back sensor), a lens, an image signal processor (ISP) or a flash (for example, LED or xenon lamp).

The power management module 295 may manage, for example, power of the electronic device 201. The power management module 295 may include a power management integrated circuit (PMIC), a charger IC, or a battery gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (e.g., a booting state, a message state, a charging state, or the like) of the electronic apparatus 201 or a part (e.g., the processor 210). The motor 298 may convert an electrical signal into mechanical vibration, and may generate vibration, a haptic effect, or the like. Although not illustrated, the electronic apparatus 201 may include a processing unit (e.g., a GPU) for supporting a mobile TV. The processing unit for supporting mobile TV may, for example, process media data according to a certain standard such as digital multimedia broadcasting (DMB), digital video broadcasting (DVB), or mediaFLO™.

Each of the above-described component elements of hardware may be configured with one or more components, and the names of the corresponding component elements may vary based on the type of electronic device. The electronic device may include at least one of the aforementioned elements. Some elements may be omitted or other additional elements may be further included in the electronic device. Also, some of the hardware components may be combined into one entity, which may perform functions identical to those of the relevant components before the combination.

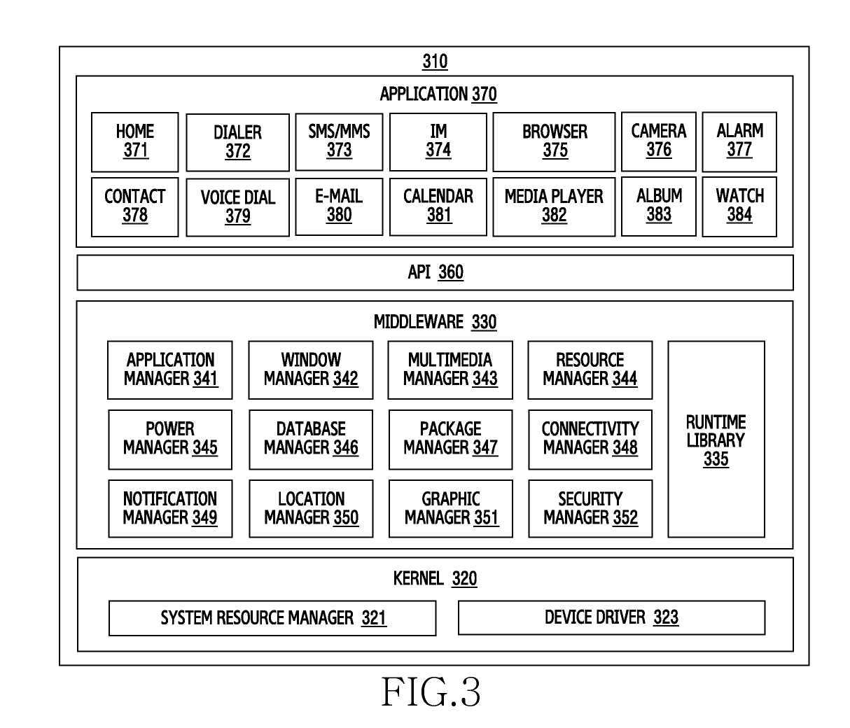

FIG. 3 is a block diagram of a program module 310, according to an embodiment of the present disclosure.

The program module 310 may include an OS for controlling resources related to electronic device 101 and/or the application programs 147 executed in the OS. The OS may be, for example, Android™, iOS™, Windows™, Symbian™, Tizen™, Bada™, or the like.

The program module 310 may include a kernel 320, middleware 330, an API 360, and/or an application 370. At least some of the program module 310 may be preloaded on the electronic apparatus, or may be downloaded from the electronic apparatus 102 or 104, or the server 106.

The kernel 320 may include, for example, a system resource manager 321 and/or a device driver 323. The system resource manager 321 may perform the control, allocation, retrieval, or the like of system resources. The system resource manager 321 may include a process manager, a memory manager, a file system manager, or the like. The device driver 323 may include, for example, a display driver, a camera driver, a BT driver, a shared memory driver, a USB driver, a keypad driver, a Wi-Fi driver, an audio driver, or an inter-process communication (IPC) driver.

The middleware 330 may provide a function required by the applications 370 in common or provide various functions to the applications 370 through the API 360 so that the applications 370 can efficiently use limited system resources within the electronic device. The middleware 330 may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may perform input/output management, memory management, the functionality for an arithmetic function, or the like.

The application manager 341 may manage, for example, the life cycle of at least one of the applications 370. The window manager 342 may manage GUI resources used for the screen. The multimedia manager 343 may determine a format required to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a basic input/output system (BIOS) to manage a battery or power and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or BT. The notification manager 349 may display or notify of an event, such as an arrival message, an appointment, a proximity notification, and the like, in such a manner as not to disturb the user. The location manager 350 may manage location information of the electronic apparatus. The graphic manager 351 may manage a graphic effect, which is to be provided to the user, or a user interface related to the graphic effect. The security manager 352 may provide various security functions required for system security, user authentication, and the like. When the electronic apparatus has a telephone call function, the middleware 330 may further include a telephony manager for managing a voice call function or a video call function of the electronic apparatus.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 is, for example, a set of API programming functions, and may be provided with a different configuration according to an OS. For example, in the case of Android™ or iOS™, one API set may be provided for each platform. In the case of Tizen™, two or more API sets may be provided for each platform.

The applications 370 may include, for example, one or more applications which can provide functions such as home 371, dialer 372, SMS/MMS 373, instant message (IM) 374, browser 375, camera 376, alarm 377, contacts 378, voice dialer 379, email 380, calendar 381, media player 382, album 383, clock 384, health care (for example, measure exercise quantity or blood sugar levels), or environment information (for example, atmospheric pressure, humidity, or temperature information).

The applications 370 may include an information exchange application supporting information exchange between the electronic apparatus 101 and the electronic apparatus 102 or 104. The application associated with information exchange may include, for example, a notification relay application for forwarding specific information to an external electronic device, or a device management application for managing an external electronic device.

For example, the notification relay application may include a function of delivering, to the electronic apparatus 102 or 104, notification information generated by other applications (e.g., an SMS/MMS application, an email application, a health care application, an environmental information application, etc.) of the electronic apparatus 101. Further, the notification relay application may receive notification information from, for example, an external electronic device and provide the received notification information to a user.

The device management application may manage (for example, install, delete, or update), for example, a function for at least a part of the electronic device 102 or 104 communicating with the electronic device (for example, turning on/off the electronic device 102 or 104 itself (or some elements thereof) or adjusting brightness (or resolution) of a display, applications executed in the external electronic device, or services provided from the external electronic device (for example, a telephone call service or a message service).

The applications 370 may include applications (for example, a health care application of a mobile medical appliance or the like) designated according to attributes of the electronic device 102 or 104. The application 370 may include an application received from the server 106, or the electronic device 102 or 104. The application 370 may include a preloaded application or a third party application which can be downloaded from the server. Names of the elements of the program module 310 may change depending on the type of OS.

At least some of the program module 310 may be implemented in software, firmware, hardware, or a combination of two or more thereof. At least some of the program module 310 may be implemented (e.g., executed) by, for example, the processor 210. At least some of the program module 310 may include, for example, a module, a program, a routine, a set of instructions, and/or a process for performing one or more functions.

The module or the program module may include one or more elements described above; exclude some of them; or further include other elements. The operations performed by the module, the program module, or other elements, may be executed in a sequential, parallel, iterative, or heuristic method. In addition, some operations may be executed in a different order, or may be omitted, or other operations may be added.

An electronic device according to various embodiments of the present disclosure can include a camera operatively coupled with the electronic device, a microphone operatively coupled with the electronic device, a memory, a communication circuit, and a processor. The processor can acquire at least one image corresponding to one or more objects through the camera, acquire a first sound source and a second sound source that are sensed in association with the acquiring operation through the microphone, generate first sound source information corresponding to the first sound source and second sound source information corresponding to the second sound source, and store the at least one image in the memory in a state in which the at least one image is associated with the first sound source information and the second sound source information.

The processor can store such that the first sound source and the second sound source are played independently of each other, and designate the first sound source information as a first attribute that shall be used at the playing, and the second sound source information as a second attribute that shall be used at the playing.

The processor can identify media content corresponding to the sound source, and associate and store information on the media content and the sound source information.

The processor can perform the searching of the media content corresponding to the sound source for the electronic device or an external device, using the sound source, and determine the media content, based on the searching.

The processor can control the communication circuit to request the media content from the electronic device to an external device, and store the media content that is acquired in response to the request in the memory.

The processor can identify another at least one image that is stored in association with third sound source information, and group the at least one image and the another at least one image, based on that the first sound source information or the second sound source information is related with the third sound source information.

The processor can control the communication circuit to transmit the first sound source information, the second sound source information, and the at least one image that is stored in the memory in a state of being associated with the first sound source information and the second sound source information, from the electronic device to an external device.

The processor can, if the external device is a legacy device, transcode or synthesize the image and the first sound source information or the second sound source information, and control the communication circuit to transmit information generated by the transcoding or synthesizing operation to the legacy device.

The processor can acquire the first sound source and the second sound source using at least one of receive beamforming and a control of an amplification gain of the microphone.

An electronic device according to various embodiments of the present disclosure can include a camera operatively coupled with the electronic device, a microphone operatively coupled with the electronic device, a display operatively coupled with the electronic device, a speaker operatively coupled with the electronic device, a memory storing first sound source information corresponding to a first sound source and second sound source information corresponding to a second sound source, a communication circuit, and a processor. The processor can check a selection of at least one image, the first sound source and the second sound source being acquired at the same image photographing time point, display the at least one image through the display, and in association with the displaying, play the first sound source using a first attribute and the second sound source using a second attribute, independently of each other, through the speaker.

The processor can play at least a part of media content as at least a part of the first sound source or the second sound source through the speaker.

The processor can use the communication circuit to request first media content or second media content from the electronic device to at least one external device, and receive the first media content or the second media content from the at least one external device.

The first attribute and the second attribute can include playing or non-playing, a sound quality, a sound volume, a timbre, a speed, a length or a combination of them, and the processor can control the first attribute or the second attribute.

The processor can display an interface corresponding to the content, through the display, and control the playing, based on an input inputted to the interface.

The processor can associate and display the plurality of sound source information and the content through the display.

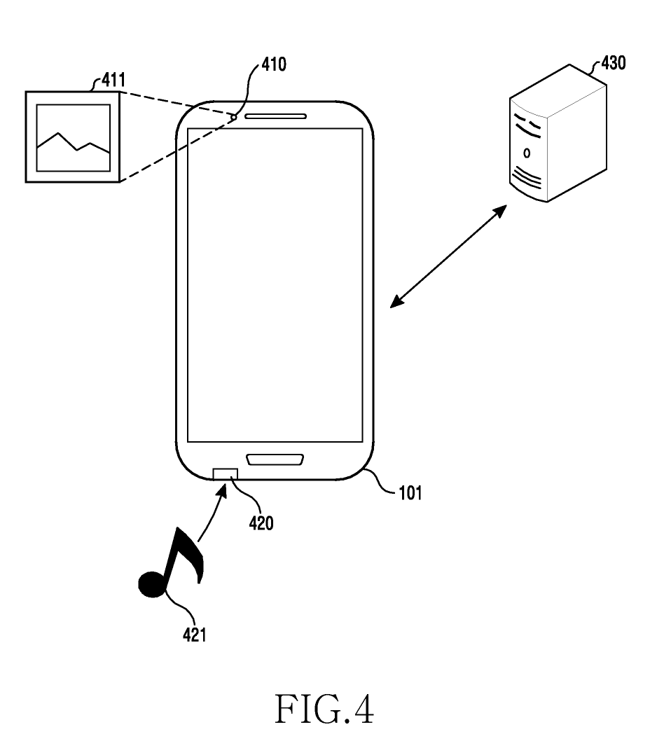

FIG. 4 is a diagram of a method for providing content, according to an embodiment of the present disclosure.

Referring to FIG. 4, the electronic device 101 can acquire an image 411 that is photographed through at least one camera module 410 operatively coupled with the electronic device 101, and can acquire a sound source corresponding to sound 421 that is inputted through at least one microphone 420 operatively coupled with the electronic device 101. The sound source can correspond to an object extracted from the sound 421. For example, the electronic device 101 can acquire a sound source (or sound source data) by processing (or handling) the sound 421 that is inputted through the at least one microphone 420. Though not illustrated in FIG. 4, the electronic device 101 can acquire an image and a sound source by receiving the image and the sound source from at least one of at least one another electronic device (e.g., peripheral device), a wearable device (e.g., a HMD, a watch type device, etc.), etc. that are linked (or communication coupled) with the electronic device 101 and include at least one of the camera module 410 and the microphone 420.

The electronic device 101 can get inputted sound from the surroundings of the electronic device 101 through at least one microphone 420. A sound source corresponding to sound inputted from the surroundings of the electronic device 101 can include a sound source related to music. The sound source corresponding to the sound inputted from the surroundings of the electronic device 101 can include a peripheral sound source. The sound source corresponding to the sound inputted from the surroundings of the electronic device 101 can include a sound source related with music and a peripheral sound source.

A sound source corresponding to sound traveling from the surroundings of the electronic device 101 through at least one microphone 420 operatively coupled to the electronic device 101 can be referred to as a ‘whole sound source’, and the ‘whole sound source’ is used together with a ‘sound source’. Also, in a case where the whole sound source includes music information, the music information included in the whole sound source can be referred to as a ‘music-related sound source’. Also, a sound source exclusive of a sound source related with music among information included in the whole sound source can be referred to as a ‘peripheral sound source’.

The music-related sound source can include sound sources, etc. corresponding to music inputted by playing on musical instruments, music (e.g., a song) inputted based at least on a voice, humming, etc. The music-related sound source can include a sound source corresponding to music that is played with a peripheral device of the electronic device 101.

To acquire media content corresponding to a music-related sound source, the electronic device 101 can transmit at least a part of a whole sound source acquired from the microphone 420 to an external device.

To acquire media content corresponding to a music-related sound source, the electronic device 101 can perform a comparison of whether there is a section in which at least a part of information related with the music-related sound source is the same as or is similar with media content (e.g., a music file, a moving-picture file, etc.) stored in the electronic device 101. Based on the comparison result, the electronic device 101 can determine a media file of which a sameness or similarity satisfies a designated range (e.g., if a similarity of a five second section of at least a part of information related with the music-related sound source is 90% or more), as the media content corresponding to the music-related sound source.

The electronic device 101 can acquire music information (or media content) corresponding to a music-related sound source, and determine if the music-related sound source corresponds to a section of the acquired music information. When playing the music information, the electronic device 101 can use information on the section for playing only by the section.

The external device 430 can include a music search system (or a media content search system). For example, the external device 430 can include a server and a database for searching media content (or information on the media content) corresponding to a music-related sound source (or corresponding to a whole sound source) included in the whole sound source, based on at least a part of the whole sound source received from the electronic device 101. The media content corresponding to the music-related sound source can be media content that is similar (or has a high concordance rate) with the music-related sound source. If the media content corresponding to the music-related sound source is searched within the database of the external device 430, the external device 430 can transmit the searched media content (or information on the media content) to the electronic device 101. The media content corresponding to the music-related sound source searched through the searching operation of the external device 430 can be referred to as ‘searched media content’. The searched media content can include at least one of searched media content (or a sound source file, or sound source data, or source data), meta data (e.g., data, etc. including information on at least one of a music name, a singer, a songwriter, a songster, etc.) of the searched media content, length or playing time information on a section corresponding to a music-related sound source among the entire section of the searched media content, link information (e.g., information on a uniform resource locator (URL), a website, etc. for downloading searched music) of the searched media content, etc. The external device 430 can include a server for performing an operation of searching media content corresponding to a music-related sound source, an operation of communication with the electronic device 101, etc. In an instance where the external device 430 includes the server performing the searching operation, the communication operation, etc., the external device 430 can request a searched media content file to a media content service provider (or a media content service provision device). If the external device 430 receives the searched media content file from the media content service provider, the external device 430 can transmit the received searched media content file to the electronic device 101.

The electronic device 101 can receive searched media content from the external device 430, and store the received searched media content. For example, the electronic device 101 can store the searched media content along with an image acquired through a photographing operation and a whole sound source, in the memory 130. In another example, the electronic device 101 can link (or associate or map) the searched media content with the image and the whole sound source, and store the searched media content together with the image acquired through photographing and the whole sound source in the memory 130. The electronic device 101 can synthesize the image acquired through photographing and the whole sound source, and store data generated by the synthesis in the memory 130.

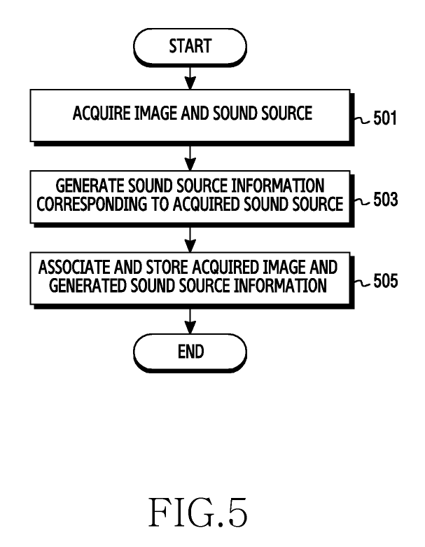

A more detailed description is made with reference to FIG. 5 to FIG. 10, in relation to an operation in which the electronic device 101 acquires searched media content based on an image acquired using the camera module 410 and a whole sound source acquired using the microphone 420, and stores the searched media content together with information on the acquired image and a whole sound source.

The electronic device 101 can selectively output (or play) searched media content together with an acquired image and a whole sound source stored in the memory 130. For example, the electronic device 101 can execute a gallery application, etc. to display an acquired image and concurrently selectively output a whole sound source, a peripheral sound source, a music-related sound source, searched media content, etc. In another example, while the electronic device 101 displays the acquired image and outputs any one of the whole sound source, the peripheral sound source, the music-related sound source, or the searched media content, the electronic device 101 can output a sound source other than the currently outputted sound source in place of the currently outputted sound source, based at least on a user input.

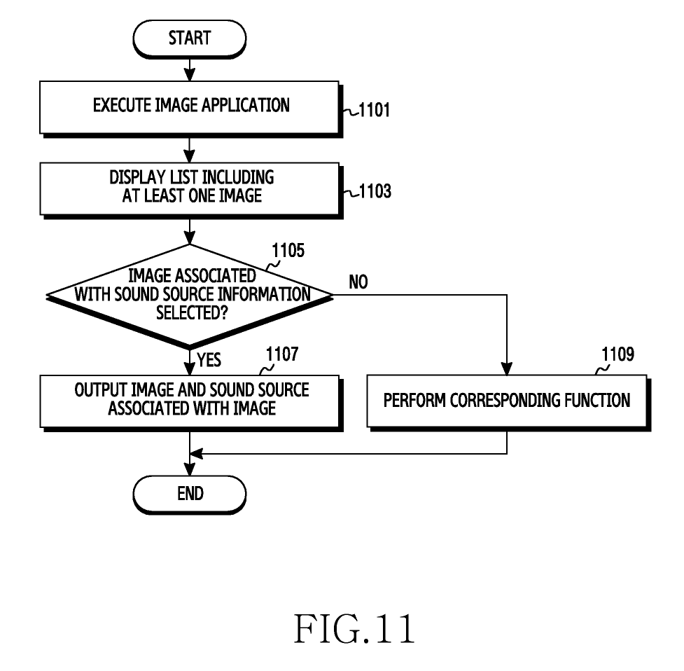

A more detailed description is made with reference to FIG. 11 to FIG. 14, in relation to an operation in which the electronic device 101 selectively outputs (or plays) searched media content together with an acquired image and a whole sound source.

The electronic device 101 can share searched media content together with an acquired image and a whole sound source with another device (or a user of another device). For example, the electronic device 101 can transmit the searched media content together with the acquired image and the whole sound source to another electronic device 101, or upload the same to a cloud.

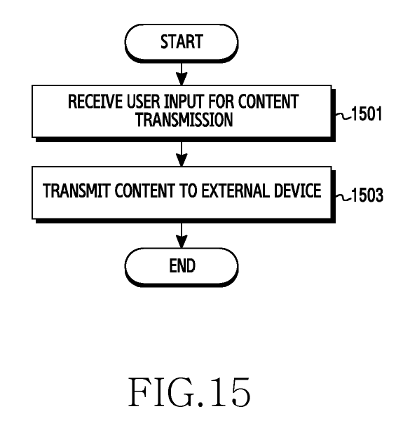

A more detailed description is made with reference to FIG. 15 to FIG. 18, in relation to an operation in which the electronic device 101 shares searched media content together with an acquired image and a whole sound source with another device.

FIG. 5 is a flowchart of a method for providing content, according to an embodiment of the present disclosure.

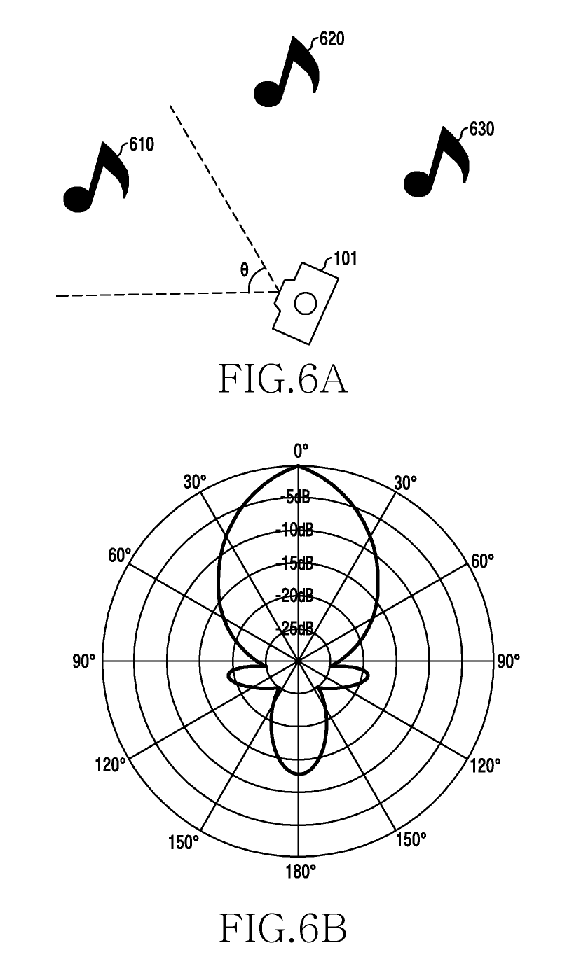

FIGS. 6A and 6B are diagrams of a method for acquiring a music-related sound source and a peripheral sound source, according to an embodiment of the present disclosure.

Referring to FIG. 5 to FIG. 6B, in step 501, the processor 120 can acquire an image using the camera module 291 electrically coupled to the electronic device 101, and acquire a sound source using the microphone 288 also electrically coupled to the electronic device 101.

The processor 120 can concurrently perform an operation of acquiring an image and an operation of acquiring a sound source. For example, the processor 120 can acquire an image and concurrently acquire a sound source, by executing a moving-picture or video call function. In another example, in a case of a sound and shot function, the processor 120 can acquire a sound source for a designated time after a photographing operation (e.g., a camera shutter pressing operation, etc.), or acquire the sound source for a designated time before the photographing operation.

The processor 120 can acquire an image and a sound source, by receiving the image and the sound source from at least one of another electronic device (e.g., peripheral device), and a wearable device that are linked (or in operative communication (e.g., wired or wireless communication)) with the electronic device 101 and include at least one of a camera module and a microphone.

The image can include a still image (e.g., a photo), a moving image (e.g., a video), etc.

A sound source, for example, a sound source (a ‘whole sound source’) corresponding to sound inputted from the surroundings of the electronic device 101 through at least one microphone 288 electrically coupled to the electronic device 101 can include a sound source related with music (a ‘music-related sound source’). The music-related sound source can include a sound source corresponding to at least one of music inputted by playing on musical instruments, music (e.g., song) inputted based at least on a voice, humming, etc. The music-related sound source can include a sound source corresponding to music that is played by a peripheral device of the electronic device 101.

The whole sound source can include a peripheral sound source, not a music-related sound source. For example, the peripheral sound source can include at least one of peripheral environment sound (e.g., wind sound, wave sound, etc.), peripheral sound (e.g., car sound, etc.), dialogue sound between neighboring persons, etc. that are inputted to the electronic device 101 during the execution of a moving-picture, video call, or sound and shot function. The peripheral sound source can include all of a sound source corresponding to sound exclusive of the music-related sound source among the whole sound source.

In an instance where a plurality of sounds are received from the surroundings of the electronic device 101, the electronic device 101 can acquire a sound source (e.g., a music-related sound source) that a user desires, by using receive beamforming or by controlling a gain of at least one microphone 288.

For example, as illustrated in FIG. 6A, in a case where a plurality of sounds 610, 620, and 630 traveling from a plurality of different directions are possible to be inputted to the electronic device 101 from the surroundings of the electronic device 101, a user can face the electronic device 101 to a direction to which sound that the user wants inputted (or recording) travels. The electronic device 101 can acquire a sound source (e.g., a music-related sound source) that the user wants, by getting inputted sound traveling within a range of a set angle using receive beamforming. The electronic device 101 may use the receive beamforming for obtaining inputted sound traveling within a range other than a set angle, or may use the receive beamforming for obtaining sound having low energy (or negligible energy).

The electronic device 101 can acquire sound that a user wants, by controlling a gain (e.g., an amplification gain) of the microphone 288 included in the electronic device 101. For example, the electronic device 101 can include an omni-directional microphone, a uni-directional microphone, an ultra directional microphone, etc. For example, FIG. 6B illustrates a sensitivity of an ultra directional microphone and a radius thereof. The ultra directional microphone can respond with a high sensitivity to sound that is inputted to the front of the electronic device 101 at a relatively narrow angle (e.g., 30 degrees or less), and respond with a low sensitivity to sound that is inputted at other angles. Though not illustrated, the omni-directional microphone can respond with the same sensitivity to sound that is inputted at all angles, and the uni-directional microphone can respond with a high sensitivity to sound that is inputted to the front right and left of the electronic device 101 (e.g., at an angle of 90 degrees or less). In the instance where a plurality of sounds traveling from a plurality of different directions are able to be inputted to the electronic device 101 from the surroundings of the electronic device 101, a user can face the electronic device 101 to a direction to which sound that the user wants inputting (or recording) travels. In a state in which the electronic device 101 faces the direction to which the sound that the user wants travels, the processor 120 increases a gain of an ultra directional microphone 288 and decreases gains of an omni-directional microphone 288 and a uni-directional microphone 288, thereby enabling the user to acquire a desired sound source.

In step 503, the electronic device 101 can generate sound source information corresponding to the acquired sound source. For example, the electronic device 101 can generate information on the acquired sound source, information on media content corresponding to a music-related sound source included in the acquired sound source, etc. The information on the media content corresponding to the music-related sound source can include at least one of a media content file, meta data (e.g., data, etc. including information on at least one of a music name, a singer, a songwriter, a songster, etc.) of the media content, length or playing time information on a section corresponding to the music-related sound source among the entire section of searched media content, and/or a link (e.g., a URL, a website, etc. for downloading searched music) of the media content. The information on the media content can include a media content file stored within the electronic device 101, directory information, etc.

The electronic device 101 can generate a plurality of sound source information. For example, the plurality of sound source information can include information on at least one of a whole sound source, a peripheral sound source, a music-related sound source, and media content corresponding to the music-related sound source. In another example, in a case where a plurality of music-related sound sources are the plurality of sound source information included in the whole sound source, or in a case where a plurality of music are inputted to the electronic device 101 from the surroundings of the electronic device 101, the electronic device 101 can generate sound source information on each of the plurality of music-related sound sources.

The electronic device 101 can acquire information on media content corresponding to a music-related sound source, etc. through an external device.

To acquire information on media content corresponding to a music-related sound source, etc. through the external device, the electronic device 101 can transmit a sound source to the external device (e.g., a music search service provision server). For example, the processor 120 can control the communication interface 170 to transmit an acquired whole sound source to the external device.

The electronic device 101 can transmit at least a part of a whole sound source to the external device. For example, the electronic device 101 can transmit to the external device a sound source that is acquired during the entire or partial time duration among a time duration acquiring the whole sound source. In another example, while acquiring the whole sound source, the electronic device 101 can transmit an acquired sound source to the external device in real-time or at a designated period of time.

In a case where it is a designated condition, the electronic device 101 can transmit an acquired whole sound source to the external device.

For example, in a function of continuously acquiring a plurality of images such as a continue shot (or burst shot) function or a video record function, in a case where an interval of time (e.g., an interval of time between a previous image acquisition time and a current image acquisition time) acquiring each of the plurality of images is less than a threshold value (or threshold time), the electronic device 101 may not transmit an acquired whole sound source to the external device. In another example, in a case where the interval of time acquiring each of the plurality of images is greater than or equal to the threshold value (or threshold time), the electronic device 101 can transmit the acquired whole sound source to the external device.

In a case where a motion (e.g., movement, direction change, etc.) of the electronic device 101 is less than a designated threshold value, the electronic device 101 may not transmit an acquired whole sound source to the external device. In another example, if the motion of the electronic device 101 is greater than or equal to the designated threshold value, the electronic device 101 can transmit the acquired whole sound source to the external device. The motion of the electronic device 101 can correspond to a motion (or movement) of a user.

Step 503 can further include an operation of determining if a whole sound source includes a music-related sound source. For example, the processor 120 can determine if the whole sound source includes the music-related sound source. If determining that the whole sound source includes the music-related sound source, the processor 120 can control the communication interface 170 to transmit the whole sound source to the external device. If determining that the whole sound source does not include the music-related sound source (for example, if determining that the whole sound source includes only a peripheral sound source), the electronic device 101 may not transmit the whole sound source to the external device, and can store the acquired image and whole sound source in the memory 130.

The processor 120 may receive media content corresponding to a music-related sound source from the external device. The processor 120 can receive a whole sound source, or media content corresponding to a music-related sound source included in the whole sound source, or information on the media content from the external device through a searching operation.

The media content corresponding to the music-related sound source or the information on the media content received from the external device can include at least one of a searched media content file (or a sound source file, sound source data, a video file (or a moving-picture file), or source data), length or playing time information on a section corresponding to a music-related sound source among the entire section of searched media content, meta data (e.g., data including information on at least one of a music name, a singer, a songwriter, a songster, etc.) of the searched media content, link information (e.g., information on a URL, a website, etc. for downloading the searched media content) of the searched media content, etc.

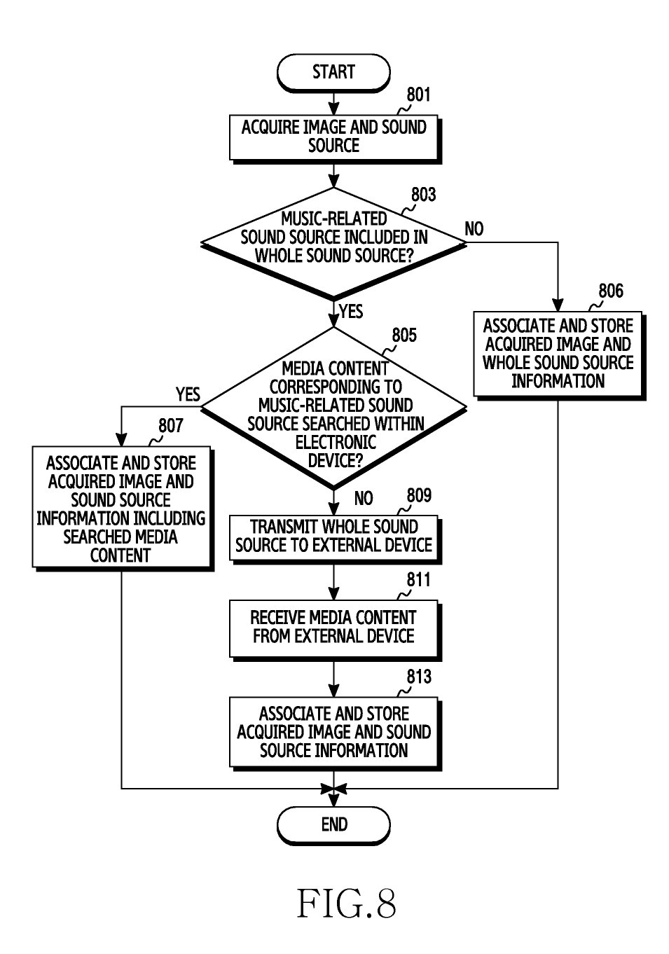

The electronic device 101 can acquire information on media content corresponding to a music-related sound source, etc. through the internal search of the electronic device 101 (or the memory 130). An operation of acquiring the information on the media content corresponding to the music-related sound source, etc. through the internal search of the electronic device 101 is described in detail with reference to FIG. 8.

In step 505, the electronic device 101 can associate and store the acquired image and the generated sound source information. For example, the electronic device 101 can store searched media content received from an external device or media content searched within the electronic device 101, together with information on the acquired image and whole sound source. In another example, the electronic device 101 can link (or associate or map) the searched media content with the image and the whole sound source and store the searched media content together with the image and whole sound source acquired through photographing in the memory 130. The electronic device 101 can synthesize the image and whole sound source acquired through photographing, and store data generated by the synthesis in the memory 130.

Step 505 can further include an operation of identifying media content corresponding to a sound source. For example, to associate and store an acquired image and media content information corresponding to sound source information, the electronic device 101 can identify media content associated with the image.

The processor 120 can store a plurality of sound source information such that the each of the plurality of sound source information can be played independently. For example, the processor 120 can store the plurality of sound source information to selectively play at least one of a whole sound source, a music-related sound source, media content corresponding to the music-related sound source, and a peripheral sound source, based at least on a user input, at playing (or outputting). The processor 120 can designate each of the plurality of sound source information as an attribute such that the plurality of sound source information can be each played independently. However, it is not limited to this.

FIG. 5 illustrates storing an image and a whole sound source after media content searching, but it is not limited to this. For example, the processor 120 can acquire an image and a whole sound source in step 501, and first store the acquired image and whole sound source in the memory 130, and perform an operation of searching media content.

In a case where a time limit of use is designated to searched media content, if the designated time limit of use lapses, the processor 120 can delete the searched media content, and store only link information of the searched media content. In a case where the time limit of use is designated to the searched media content, if the designated time limit of use lapses, the processor 120 can control the display 160 to output a message of requesting a re-purchase of the searched media content. However, it is not limited to this.

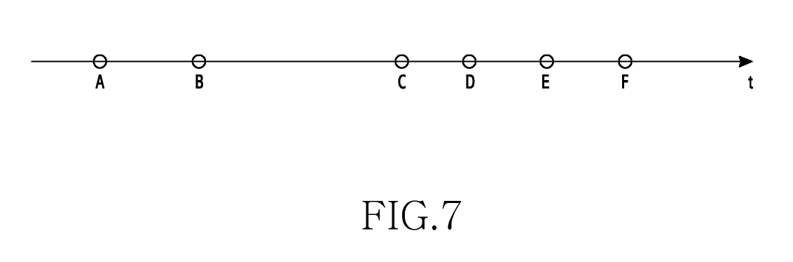

FIG. 7 is a diagram of a content acquiring and storing method, according to an embodiment of the present disclosure.

The processor 120 can adaptively determine the acquiring and storing of a sound source.

FIG. 7, illustrates an image acquisition and sound information acquisition time point, dependent on time (t) in a case of executing a sound and shot function.

A camera module 291 application execution time point (A) can be the same as a sound source start time point (B). For example, at a camera application execution, the electronic device 101 can get inputted sound (or recording) through the microphone 288. For example, the electronic device 101 can record sound inputted from the surroundings of the electronic device 101 through the microphone 288 electrically coupled with the electronic device 101.

When executing a sound and shot function (or sound and shot mode) among at least one function of the camera module 291 application, the electronic device 101 can initiate the acquiring of a sound source through the microphone 288. When executing a moving-picture recording function (or a video recording function) among at least one function of the camera module 291 application, the electronic device 101 can initiate the acquiring of a sound source through the microphone 288. The electronic device 101 can initiate the acquiring of a sound source by various inputs of a user, for example, a key input, a touch input, an input by a voice, an input by a motion of the electronic device 101, etc., after the execution of the camera module 291 application.

The processor 120 can continuously acquire a sound source, even after reception of an event (or trigger) (hereinafter, referred to as an ‘end event’) for ending sound source acquisition.

For example, in a first mode of a sound and shot function (or mode), if a photographing button pressing input (i.e., an end event) is received while a sound source is acquired, the processor 120 can acquire (or take) an image. Although acquiring the image by the reception of the photographing button pressing input, the processor 120 may not end the acquiring of a whole sound source. At reception of the end event, the processor 120 can determine if sound corresponding to a music-related sound source is continuously inputted, based at least on the music-related sound source included in the whole sound source. If determining that the sound corresponding to the music-related sound source is continuously inputted, the processor 120 can continuously acquire the whole sound source. For example, if determining that the sound corresponding to the music-related sound source is continuously acquired, the processor 120 can acquire the whole sound source by a time point (D) after a photographing button pressing input time point (C). The processor 120 can store the acquired whole sound source in the memory 130. If determining that the sound corresponding to the music-related sound source is not continuously acquired, the processor 120 can end the acquiring of the whole sound source at the reception of the end event, and store the acquired image and whole sound source.

Although not illustrated in FIG. 7, in another example, in a second mode of the sound and shot function (or mode), if the photographing button pressing input is received, the processor 120 can acquire a whole sound source even after the lapse of a time (e.g., 9 seconds) designated for the ending of sound source acquisition. For example, if receiving the end event (e.g., the lapse of a designated time from the photographing button pressing input time point (C)), the processor 120 can determine if sound corresponding to a music-related sound source is continuously acquired. If determining that the sound corresponding to the music-related sound source is continuously acquired, the processor 120 can continuously acquire the whole sound source. If determining that the sound corresponding to the music-related sound source is not continuously acquired, the processor 120 can end the acquiring of the whole sound source at reception of the end event, and store the acquired image and whole sound source.

Even when a camera module 291 application execution end input is received from a user, the processor 120 can acquire a whole sound source, depending on whether sound corresponding to a music-related sound source is continuously acquired. For example, if the camera module 291 application execution end input is received from the user, the processor 120 can determine if sound corresponding to a music-related sound source included in a whole sound source is continuously inputted. If determining that the sound corresponding to the music-related sound source is continuously acquired, the processor 120 can continuously acquire (or record) the whole sound source as a background. For example, the processor 120 can continuously acquire (or record) the whole sound source by a time point (F) after a time point (E) of reception of the camera module 291 application execution end event. If determining that the sound corresponding to the music-related sound source is continuously inputted, the processor 120 can end the acquiring of the whole sound source, when the sound corresponding to the music-related sound source is not continuously inputted (e.g., when a song is ended), or when a designated time (e.g., one minute) lapses even if the sound corresponding to the music-related sound source is continuously inputted.

The processor 120 can determine if a music-related sound source is continuously acquired through signal to noise ratio (SNR) or sound pattern analysis. For example, the processor 120 can extract a music-related sound source corresponding to a signal and a peripheral sound source corresponding to a noise, from a whole sound source. For example, if a ratio of music-related sound source amplitude to peripheral sound source is greater than or equal to a designated value, the processor 120 can determine if sound corresponding to the music-related sound source is continuously inputted. In another example, the processor 120 can determine if the sound corresponding to the music-related sound source is continuously inputted, based at least on a pattern of the whole sound source, for example, at least one of a melody, a pitch, an intensity, a timbre, a rhythm, a beat, etc.

FIG. 7 relates to the sound and shot function, but it is not limited to this. For example, it can be applied to a moving-picture function, a video call function, etc. For example, in a case where moving-picture recording is ended or video call is ended, the electronic device 101 can determine if sound corresponding to a music-related sound source is continuously inputted, based at least on the music-related sound source included in a whole sound source. If determining that the sound corresponding to the music-related sound source is continuously imputed, the electronic device 101 can continuously acquire the whole sound source.

FIG. 8 is a flowchart of a method for providing content, according to an embodiment of the present disclosure.

FIG. 8 also illustrates a process of determining if media content corresponding to a music-related sound source has been stored within the electronic device 101, before the electronic device 101 transmits a whole sound source to an external device.

Step 801 can be the same as or similar to step 501 of FIG. 5 and thus, a detailed description is omitted.

In step 803, the processor 120 can determine if a whole sound source includes a music-related sound source. For example, the processor 120 can determine if the whole sound source includes the music-related sound source, based at least on at least one of a melody of the whole sound source, a pitch, an intensity, a timbre, a rhythm, a beat, etc. A process of determining if the whole sound source includes the music-related sound source in step 803 can be omitted.

If the processor 120 determines that the whole sound source does not include the music-related sound source in step 803, for example, if the processor 120 determines that the whole sound source includes only a peripheral sound source, in step 806, the processor 120 can associate and store the acquired image and whole sound source in the memory 130 without searching the music-related sound source.

If it is determined that the music-related sound source is included in the whole sound source in step 803, in step 805, the processor 120 can search media content corresponding to the music-related sound source. For example, the processor 120 can analyze the whole sound source, and search within the electronic device 101 media content being the most similar (or having the highest concordance rate) with the music-related sound source included in the whole sound source. The processor 120 can also search if the media content being the most similar with the music-related sound source included in the whole sound source has been stored in a peripheral device, a wearable device, etc., which can be in operative communication with the electronic device 101. If it is searched that the media content being the most similar with the music-related sound source included in the whole sound source has been stored in the coupled peripheral device, wearable device, etc., the electronic device 101 can receive information on searched music from the coupled peripheral device or wearable device.

To acquire media content corresponding to a music-related sound source, the electronic device 101 can perform a comparison of whether there is a section in which at least a part of information related with the music-related sound source is the same as or is similar to media content (e.g., a music file, a moving-picture file, etc.) stored in the electronic device 101. Based on the comparison result, the electronic device 101 can determine a media file of which a sameness or similarity satisfies a designated range (e.g., if a similarity of a five second section of at least a part of information related with the music-related sound source is 90% or more), as the media content corresponding to the music-related sound source.

The electronic device 101 can acquire music information (or media content) corresponding to a music-related sound source, and determine whether the music-related sound source corresponds to which section of the acquired music information. When playing the music information, the electronic device 101 can use information on the section for playing only by the section.

The media content stored within the electronic device 101 can also include meta data (e.g., data, etc. including information on at least one of a music name, a singer, a songwriter, a songster, etc.) of the media content, length or playing time information on a section corresponding to a music-related sound source among the entire section of searched media content, link information (e.g., information on a URL, a website, etc. for downloading searched music) of the media content, etc.

The processor 120 can use various technologies (or algorithms) to search media content corresponding to a music-related sound source. For example, the processor 120 can use at least one of a symbolic analysis technology for analyzing onset information of a sheet of music, a signal-spectrum analysis technology for analyzing a sampled signal, low-level original sound analysis technology (e.g., audio beat tracking (ABT)), audio melody extraction (AME), audio onset detection (AOD), music information retrieval application technology (e.g., audio genre classification (AGC), audio tag classification (ATC), query-by-singing/humming (QBSH)), and audio fingerprinting.

If the processor 120 checks that media content corresponding to a music-related sound source is stored in the memory 130 in step 805, in step 807, the processor 120 can associate and store an acquired image, and sound source information including searched media content.

Step 807 of associating and storing the acquired image and the sound source information including the searched media content is at least partially the same as or is similar to step 505 of FIG. 5 and thus, a detailed description is omitted. If checking that the media content corresponding to the music-related sound source has not been stored in the memory 130 in step 805, in step 809, the processor 120 can transmit the whole sound source to the external device. In step 811, the processor 120 can receive media content searched in the external device from the external device. In step 813, the processor 120 can associate and store the acquired image, and sound source information including the searched media content received from the external device.

Step 809 to step 813 are at least partially the same as or are similar to step 503 to step 505 of FIG. 5 and thus, a detailed description is omitted.

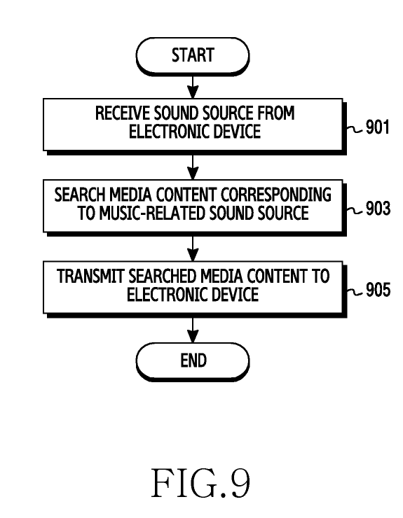

FIG. 9 is a flowchart of a method for providing content, according to an embodiment of the present disclosure. FIG. 9 also illustrates an operation in which an external device searches media content corresponding to a music-related sound source.

In step 901, the external device can receive a whole sound source from the electronic device 101. The external device can also receive a music-related sound source included in the whole sound source, from the electronic device 101 as well.

In step 903, the external device can search media content corresponding to the whole sound source that is received in step 901. The external device can search media content corresponding to a music-related sound source included in the received whole sound source.

The external device can include a music search system. For example, the external device can include a server, a database, etc. for searching media content corresponding to a music-related sound source included in the whole sound source, based on at least a part of the whole sound source received from the electronic device 101.

The external device can search media content being the most similar (or having a high concordance rate) with the whole sound source. For example, the external device can compare the whole sound source and at least one of a melody of music stored in the external device, a pitch, an intensity, a timbre, a rhythm, a beat, etc. The external device can also compare the content of the whole sound source, for example, the lyrics of whole sound, etc. with the content of the media content. The external device can determine media content being the most similar (or having the highest concordance rate) with the whole sound source among stored media contents, as the media content corresponding to the music-related sound source.

The external device can use various technologies (or algorithms) to search media content. For example, the external device can use at least one of a symbolic analysis technology for analyzing onset information of a sheet of music, a signal-spectrum analysis technology for analyzing a sampled signal, low-level original sound analysis technology (e.g., ABT), AME, AOD, music information retrieval application technology (e.g., AGC, ATC, QBSH), and audio fingerprinting.

The external device can include a server performing an operation of searching media content corresponding to a music-related sound source and an operation of communication with the electronic device 101. The external device can request a file of the searched media content to a media content service provider (or a media content service providing device). The external device can receive the file of the searched media content from the media content service provider.

In step 905, the external device can transmit the searched media content to the electronic device 101.

The searched media content can include at least one of a searched media content file (or media content data), meta data (e.g., data including information on at least one of a music name, a singer, a songwriter, a songster, etc.) of the searched media content, length or playing time information on a section corresponding to a music-related sound source among the entire section of the searched media content, link information (e.g., information on a URL, a website, etc. for downloading the searched media content) of the searched media content, etc.

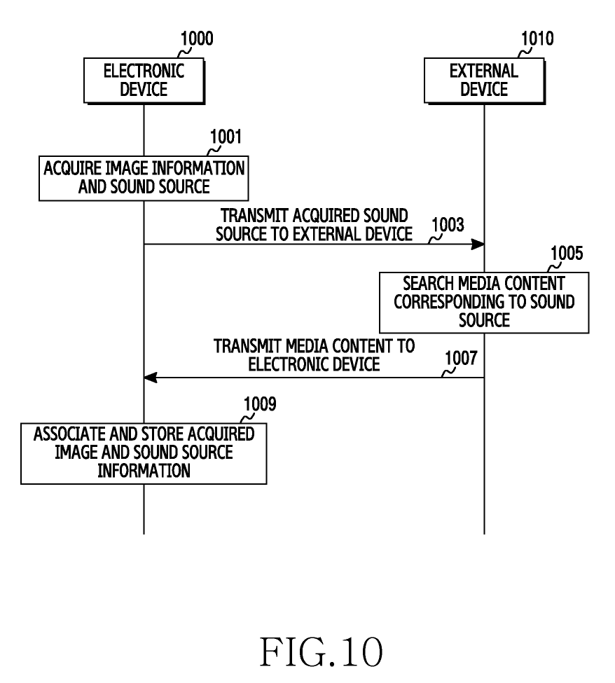

FIG. 10 is a flowchart of a system for providing content, according to an embodiment of the present disclosure.

In step 1001, an electronic device 1000 can acquire an image using the camera module 291 that is electrically coupled to the electronic device 1000, and acquire a sound source (or a whole sound source) using the microphone 288 that is electrically coupled to the electronic device 1000.

The processor 1000 can concurrently perform an operation of acquiring an image and an operation of acquiring a sound source. For example, the processor 120 can acquire the image and concurrently acquire the sound source, by executing a moving-picture or video call function.

The electronic device 1000 can acquire the image and the sound source, by receiving the image and the sound source from another electronic device 1000 (e.g., a peripheral device), a wearable device, etc. that are linked (or in operative communication (or wired or wireless communication)) with the electronic device 1000 and include at least one of the camera module 291 and the microphone 288.

The image can include a still image (e.g., a photo), a moving image (e.g., a moving-picture image), etc.

In step 1003, the electronic device 1000 can transmit the sound source to an external device 1010 (e.g., a media content search service providing server).

The electronic device 1000 can transmit at least a part of a whole sound source to the external device 1010. For example, the electronic device 1000 can transmit a sound source that is acquired during the entire or partial time duration among a time duration acquiring the whole sound source, to the external device 1010. While acquiring the whole sound source, the electronic device 1000 can transmit an acquired sound source to the external device 1010 in real-time or at a designated period of time.

In step 1005, the external device 1010 can search media content corresponding to the sound source received from the electronic device 1000.

The external device 1010 can include a media content search system. For example, the external device 1010 can include a server and database for searching information on a music-related sound source included in a sound source or music corresponding to a whole sound source, based on at least a part of the sound source received from the electronic device 1000.

The external device 1010 can search media content being the most similar (or having a high concordance rate) with a whole sound source. For example, the external device 1010 can compare the whole sound source and at least one of a melody of the media content (e.g., music content) stored in the external device 1010, a pitch, an intensity, a timbre, a rhythm, a beat, etc. The external device 1010 can use various technologies (or algorithms) to search the media content.

The external device 1010 can include a server performing an operation of searching media content corresponding to a music-related sound source and an operation of communication with the electronic device 1000. The external device 1010 can request a file of the searched media content to a media content service provider (or a media content service providing device). The external device 1010 can receive the file of the searched media content from the media content service provider.

In step 1007, the external device 1010 can transmit the searched media content to the electronic device 1000.

The searched media content can include at least one of a searched media content file (or media content data), meta data (e.g., data including information on at least one of a music name, a singer, a songwriter, a songster, etc.) of the searched media content, length or playing time information on a section corresponding to a music-related sound source among the entire section of the searched media content, link information (e.g., information on a URL, a website, etc. for downloading the searched media content) of the searched media content, etc.

In step 1009, the electronic device 1000 can store the media content received from the external device 1010, together with the acquired image and sound source information. For example, the electronic device 100 can store the acquired image, and the sound source information including the media content. In another example, the electronic device 1000 can link (or associate or map) the searched media content with the image and the whole sound source and store the searched media content together with the image and whole sound source acquired through photographing in the memory 130. The electronic device 1000 can synthesize the image and whole sound source acquired through photographing, and store data generated by the synthesis in the memory 130.

FIG. 11 is a flowchart of a method for providing content, according to an embodiment of the present disclosure.

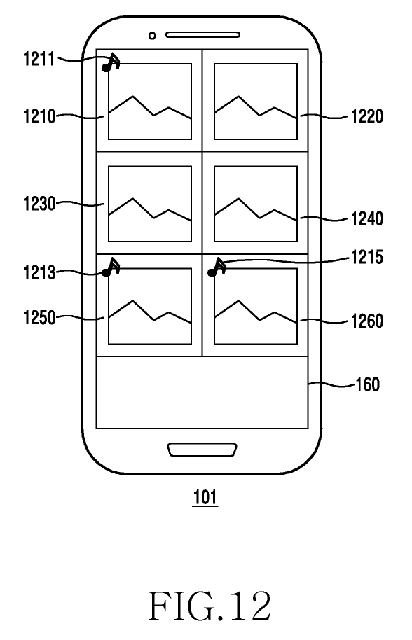

FIG. 12 is a diagram of a method for providing content, according to an embodiment of the present disclosure.

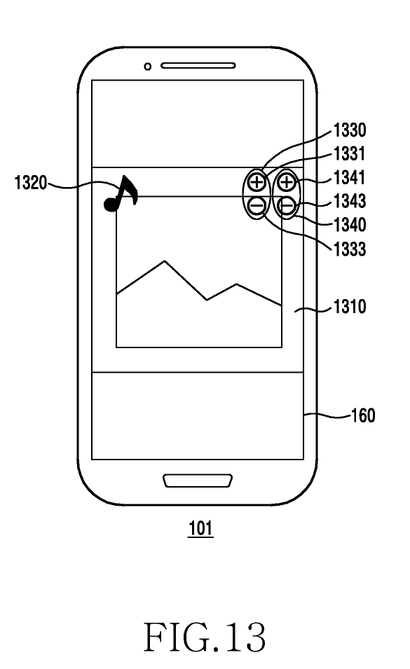

FIG. 13 is a diagram of a method for providing content, according to an embodiment of the present disclosure.

Referring to FIG. 11 to FIG. 13, in step 1101, the processor 120 can execute an image (or photo) application. For example, the processor 120 can execute a gallery application by receiving a user input.

In step 1103, the processor 120 can control the display 160 to display a list including at least one image. For example, as illustrated in FIG. 12, the processor 120 can control the display 160 to display at least one image (e.g., images 1210 to 1260) in a list of a thumbnail form. However, the images 1210 to 1260 can be displayed in various forms other than the thumbnail form.

The images 1210 to 1260 can include images 1210, 1250, and 1260 associated with sound source information and the images 1220, 1230, and 1240 not associated with the sound source information. The images 1210, 1250, and 1260 associated with the sound source information can include markers indicating that they are displaying the sound source information. For example, as illustrated in FIG. 12, the images 1210, 1250, and 1260 associated with the sound source information can include UIs (or markers) 1211, 1213, and 1215 indicating that the images 1210, 1250, and 1260 are associated with the sound source information, such that the images 1210, 1250, and 1260 are distinguished from the images 1220, 1230, and 1240 not associated with the sound source information.

In step 1105, the processor 120 can determine if an image associated with sound source information is selected. For example, the processor 120 can determine if an input of selecting the image associated with the sound source information is received from a user.

In step 1107, if the image associated with the sound source information is selected in step 1105, the processor 120 can control the display 160 and the speaker 282 to output the selected image and the sound source information associated with the selected image, respectively.

For example, as illustrated in FIG. 13, the processor 120 can control the display 160 to display the selected image, and control the speaker 282 to output the sound source information associated with the selected image.

The sound source information associated with the image can include sound source information corresponding to a sound source that is acquired at image acquisition (or photographing) or during the image acquisition. The sound source information can include a whole sound source, a music-related sound source, a peripheral sound source, searched media content, etc. The processor 120 can control the speaker 282 to output the entire sound source (i.e., the whole sound source) that is recorded at image acquisition (or photographing) or during the image acquisition, or output sound (i.e., a peripheral sound source) eliminating a music portion from the recorded entire sound source, or output only the music portion (i.e., a music-related sound source) eliminating the peripheral sound source from the recorded entire sound source, or output media content searched in an external device (or the electronic device 101) and corresponding to the music-related sound source. The processor 120 can also control the speaker 282 to concurrently output the peripheral sound source and the searched media content as well.

When outputting a whole sound source, a peripheral sound source, media content, a music-related sound source, or a peripheral sound source and searched media content, the processor 120 can use an attribute (e.g., playing or non-playing, a sound quality, a sound volume, a timbre, a speed, a length or a combination of them) corresponding to each of the whole sound source, the peripheral sound source, the media content, the music-related sound source, or the peripheral sound source and searched media content. For example, the processor 120 can control a volume (or a sound volume) of a sound source, based on a user input. For example, as illustrated in FIG. 13, the processor 120 can control the display 160 to display buttons for adjusting sound source volumes. A button 1330 can be used for adjusting a volume of the peripheral sound source, and a button 1340 can be used for adjusting a volume of the searched media content. For example, the processor 120 can control the speaker 282 to output a high volume of the peripheral sound source if getting an input to a button 1331 included in the button 1330, and output a low volume of the peripheral sound source if getting an input to a button 1333. In another example, the processor 120 can control the speaker 282 to output a high volume of the searched media content if getting an input to a button 1341 included in the button 1340, and output a low volume of the searched media content if getting an input to a button 1343. While FIG. 13 illustrates two buttons for adjusting the volumes of the peripheral sound source and the searched media content, a button for adjusting a volume of at least one of a whole sound source, a peripheral sound source, media content, a music-related sound source, or a peripheral sound source and searched media content can also be provided. For example, the processor 120 can control the speaker 282 to output any one sound source among the whole sound source, the peripheral sound source, the media content, the music-related sound source, or the peripheral sound source and searched media content, and control the display 160 to output a toggle button for outputting other sound sources in place of a sound source currently outputted and a button for adjusting a volume of the sound source currently outputted, etc.

Volume adjustment, or output change from a currently outputted sound source (e.g., whole sound source) to another sound source (e.g., searched media content) can be executed in various input schemes. For example, as illustrated in FIG. 13, the volume adjustment can be made or the output change from currently outputted sound to another sound can be made, based on at least one of a hard button (e.g., key) input, a motion of the electronic device 101, a voice input, etc., in addition to a touch input to a button (or virtual button).

The processor 120 can control the display 160 to output a button for control of various sound sources (or attributes of the sound sources) other than the volume adjustment or the output change from the currently outputted sound source (e.g., whole sound source) to another sound source (e.g., the searched media content). For example, the processor 120 can control the display 160 to output a button for controlling a speed of a currently outputted sound source, and various control buttons for executing at least one of reverse, forward, stop, pause, etc.

At user input for image selection, the processor 120 can designate and output as a default at least one of a whole sound source associated with an image, a peripheral sound source, media content, a music-related sound source, or a peripheral sound source and searched media content.

When outputting searched media content, the processor 120 can control the speaker 282 to output a media content file that is received, for example, downloaded from an external device. When outputting the searched media content, the processor 120 can identify link information (e.g., information on a URL, a website, etc. for downloading the searched media content) of the searched media content, received from the external device, and control the speaker 282 to output a sound source in a streaming manner from a media content service provider (or a media content service providing device) based on the link information.

The processor 120 can control the speaker 282 to output sound source information while displaying a selected image. For example, in a sound and shot function, the processor 120 can output the image and the sound source information only for a sound source acquisition time. In another example, in the sound and shot function, the processor 120 can keep outputting the image (for example, if a user intends to keep watching the image) even though the sound source acquisition time is exceeded, and repeatedly output (or play) stored sound source information while outputting the image. In a further example, in the sound and shot function, the processor 120 can keep outputting the image even though the sound source acquisition time is exceeded, and continuously outputting (or playing) searched media content while outputting the image. In the sound and shot function, the processor 120 can keep outputting the image even though the sound source acquisition time is exceeded, and repeatedly output a peripheral sound source while outputting the image.

In step 1109, if the image associated with the sound source information is not selected in step 1105, the processor 120 can perform a corresponding function. For example, if an image not associated with the sound source information is selected, the processor 120 can control the display 160 to display the selected image.

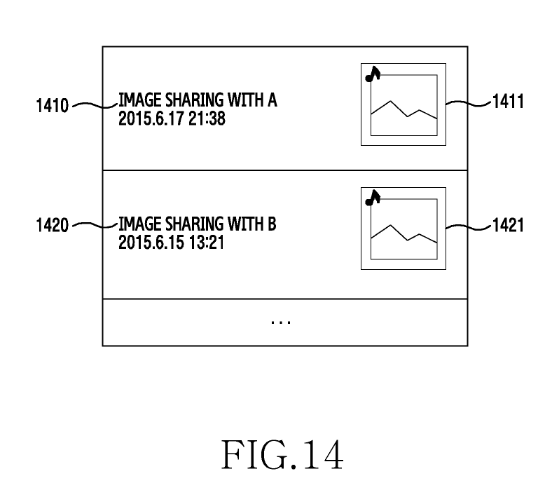

FIG. 14 is a diagram of a method for providing content, according to an embodiment of the present disclosure. FIG. 14 also shows a screen illustrating a record (or log or history) of video call or image share application execution.

If the processor 120 ends the execution of a video call or image share application, the processor 120 can provide a record of video call or image share that has ever been executed.

For example, as illustrated in FIG. 14, the processor 120 can control the display 160 to display information 1410 and 1420 on counterparts, etc. who have ever performed video call, images 1411 and 1421 outputted from the electronic device 101 or received from the counterparts during the video call, etc., in order of video call execution time. When a video call record is plural, the processor 120 can control the display 160 to display the image 1411 or 1421 of each of the plurality of video call records in a thumbnail form. The image 1411 or 1421 can be an image able to represent the video call record. The image 1411 or 1421 can include a marker indicating that the image 1411 or 1421 is associated with sound source information.

FIG. 15 is a flowchart of a content sharing method, according to an embodiment of the present disclosure.

Referring to FIG. 15, in step 1501, the processor 120 can receive a user input for content transmission (or sharing). For example, the processor 120 can receive a user input for transmitting sound source information together with an acquired image to the electronic device 101, a server, a cloud, etc.

In step 1503, the processor 120 can control the communication interface 170 to transmit (or share) content, based at least on the received user input.

For example, the processor 120 can transmit an acquired and stored image and sound source information to the external device, using a sound and shot function or moving-picture function. The sound source information can include at least one of a whole sound source, searched media content, etc. The searched media content can include at least one of not only a media content file but also meta data (e.g., data, etc. including information on at least one of a music name, a singer, a songwriter, a songster, etc.) of media content, length or playing time information on a section corresponding to a music-related sound source among the entire section of the searched media content, link information (e.g., a URL, a website, etc. for downloading searched music) of the media content, etc. In another example, the processor 120 can transmit the acquired image and the sound source information to the external device in real-time, using a video call function. In a further example, the processor 120 can transmit the acquired image and the sound source information to the external device, using an image share application.

In a case where the electronic device 101 transmits searched media content together with an acquired image and whole sound source to the external device, and selectively controls the outputting of the whole sound source, the searched media content, etc. through a user input, the external device can output the whole sound source, the searched media content, etc., in accordance with the control of the electronic device 101. For example, in a case where the electronic device 101 controls the outputting of searched media content, etc. during the execution of a video call or image share application, the electronic device 101 can control the external device to output the searched media content. In a case where the electronic device 101 transmits the searched media content together with the acquired image and whole sound source to the external device, the external device can selectively output the whole sound source, the searched media content, etc. through an external device user input.

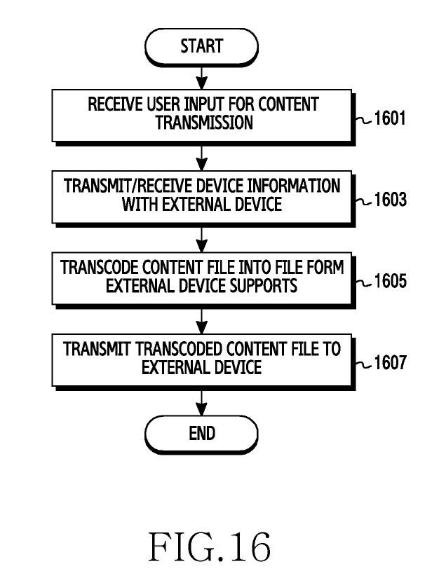

The external device can include a legacy device. For example, the legacy device can be the electronic device 101 that does not provide a sound and shot function. The legacy device can be a device that does not support a content provision function. A detailed description is made with reference to FIG. 16, in relation to a method of transmitting (or sharing) content to the legacy device.

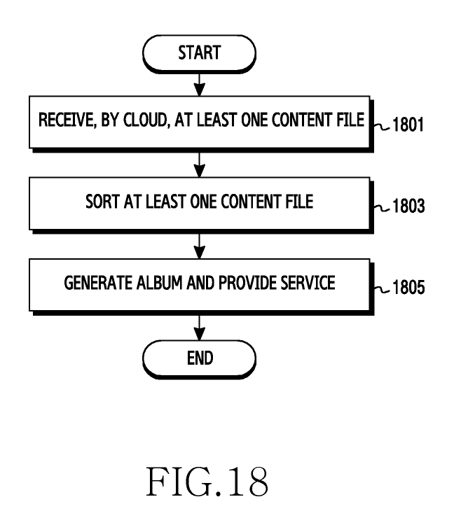

The external device can be a cloud compatible device. The cloud compatible device can provide various services to the electronic device 101, based at least on content received from the electronic device 101. A detailed description is made with reference to FIG. 18, in relation to a method of transmitting content to a cloud compatible device and receiving various services from the cloud.

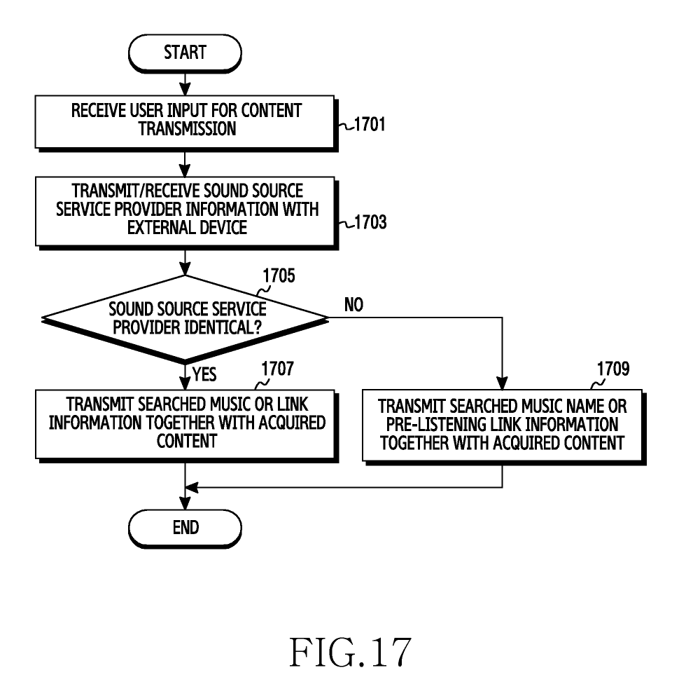

The electronic device 101 can transmit another sound source information to an external device, depending on whether a user of the external device (e.g., a counterpart electronic device 101) uses the same sound source provision service as a user of the electronic device 101. A detailed description is made with reference to FIG. 17, in relation to a method in which the electronic device 101 transmits content to the external device depending on whether the user of the external device uses the same sound source provision service as the user of the electronic device 101.

FIG. 16 is a flowchart of a content sharing method, according to an embodiment of the present disclosure, e.g., FIG. 16 relates to a method of sharing content with a legacy device.

Referring to FIG. 16, in step 1601, the processor 120 can receive a user input for transmitting (or sharing) content to an external device (e.g., a legacy device). For example, the processor 120 can receive a user input for transmitting sound source information together with an acquired image to the legacy device.

The legacy device can be an electronic device that does not provide a sound and shot function. In another example, for example, the legacy device can also be a device that does not support a content provision function. The legacy device can include various electronic devices such as a PC, a lap-top, a smart phone, etc.

In step 1603, the processor 120 can control an operation of a transmitting/receiving device information with the external device, by using the communication interface 170. For example, the device information can include at least information among sound and shot function support or non-support, camera module 291 application support or non-support, video call function support or non-support, a manufacturing company name, a device name, a device type, etc.

The processor 120 can determine whether the external device is a legacy device, based at least on the device information received from the external device. For example, the processor 120 can determine whether the external device does not support the sound and shot function, based on the received device information.

In step 1605, the processor 120 can transcode or synthesize a content file into a file form the external device supports. For example, the processor 120 can transcode or synthesize an image and sound source information file acquired and stored through the sound and shot function, into a general video form (or format). For example, the processor 120 can transcode or synthesize the image and sound source information file acquired and stored through the sound and shot function, into a general video form such as audio video interleave (AVI), flash video (FLV) file, windows media video (WMV), moving pictures layer 4 (MP4), etc.

In step 1607, the processor 120 can control the communication interface 170 to transmit the transcoded or synthesized file to the external device.

FIG. 17 is a flowchart of a content sharing method, according to an embodiment of the present disclosure, e.g., FIG. 17 relates to a method for sharing content variously depending on whether a user of an external device (e.g., a counterpart electronic device) uses the same sound source provision service as a user of the electronic device 101.

In step 1701, the processor 120 can receive a user input for transmitting (or sharing) content to the external device. For example, the processor 120 can receive a user input for transmitting sound source information together with an acquired image to a counterpart electronic device.

In step 1703, the processor 120 can transmit/receive sound source service provider information with the external device. For example, the sound source service provider information can include information on a sound source store that provides a sound source provision service to which a device user subscribes (or registers).

In step 1705, the processor 120 can determine if a sound source provision service provider to which an electronic device user subscribes and a sound source provision service provider to which an external device user subscribes are the same as each other, based at least on the sound source provision service provider information to which the external device user subscribes, received from the external device.

If it is determined in step 1705 that the sound source provision service provider to which the electronic device user subscribes and the sound source provision service provider to which the external device user subscribes are the same as each other, in step 1707, the processor 120 can transmit a searched media content file or link information, to the external device.

For example, the processor 120 can control the communication interface 170 to transmit a searched media content file downloaded from the sound source provision service provider to which the electronic device user subscribes, together with acquired content (e.g., an acquired image and whole sound source), to the external device (e.g., counterpart electronic device).

In another example, the processor 120 can control the communication interface 170 to transmit link information included in searched media content of the electronic device 101, for example, information on a URL, a website for downloading the searched media content, to the external device.

If it is determined in step 1705 that the sound source provision service provider to which the electronic device user subscribes and the sound source provision service provider to which the external device user subscribes are different from each other, in step 1709, the processor 120 can control the communication interface 170 to transmit a music name (or a title of music) of searched media content (e.g., music) or pre-listening link information together with acquired content (e.g., an acquired image and whole sound source), to the external device.

For example, the processor 120 can control the communication interface 170 to transmit a music name, etc. of searched media content (e.g., music) to the external device such that the external device user can search the searched media content using the external device.

In another example, the processor 120 can control the communication interface 170 to transmit pre-listening link information of the sound source provision service provider to which the electronic device 101 user subscribes, to the external device such that the external device user can connect to a sound source provision service link to which the electronic device user subscribes and, for example, execute one-minute pre-listening, etc.

FIG. 18 is a flowchart of a content sharing method according to an embodiment of the present disclosure, e.g., FIG. 18 relates to a method in which an external device (e.g., a cloud compatible device) provides various services to the electronic device 101 when the electronic device 101 transmits (or uploads) content to the external device.

In step 1801, the external device (or cloud compatible device) can receive at least one content file from the electronic device 101. For example, the external device can receive searched media content together with an acquired image and whole sound source.

The searched media content the external device receives can include at least one of meta data (e.g., data, etc. including information on at least one of a music name, a singer, a songwriter, a songster, etc.) of media content, length or playing time information on a section corresponding to a music-related sound source among the entire section of the searched media content, link information (e.g., information on a URL, a website, etc. for downloading searched music) of the media content, etc. In step 1803, the external device can sort the received at least one content file. For example, the external device can group (or sort or cluster) at least one content file, for example, an image associated with sound information, depending on the sameness of the searched media content, a category, an atmosphere, a singer, a music name (or a title of music), etc., based at least on the searched media content.

The external device can sort the received at least one content file, based at least on meta data of searched media content. For example, the external device can sort an image associated with sound source information by the same music name, for example, by an image having the same music name.

The external device can sort the received at least one content file, based at least on meta data of an image. For example, the external device can sort an image associated with sound source information based on the meta data of the image, for example, position information of the electronic device 101, etc. of those times of image acquisition.

In step 1805, the external device can generate an album, and provide a service to an electronic device user.

The external device can generate an album, based at least on at least one image associated with sound source information. For example, the external device can generate a folder by at least one image associated with the sound source information, having the same music name.

The external device can generate as one file at least one image associated with sound source information, having the same music name. For example, the external device can generate a file to output the at least one image associated with the sound source information at a designated time interval in sequence, similar to a slide show function. The external device can generate a file to output sound source information associated with at least one image, for example, music applied based on a sorting the at least one image while outputting the at least one image associated with the sound source information at a designated time interval in a specific sequence. In a case where the at least one image is outputted at the designated time interval in a specific sequence, the external device can generate a file to exhibit a fade in/out effect while the outputting of each of the at least one image is converted.

The external device can generate as one file at least one image in which meta data of the image, for example, an electronic device position of those times of image acquisition is identical. For example, the external device can generate a file to output the at least one image in which the electronic device position of those times of image acquisition is identical, at a designated time interval in a specific sequence.

The external device (e.g., cloud compatible device) can share content by enabling an electronic device user or another user to connect to the external device and output a generated album.

FIGS. 1 to 18 are examples of an electronic device 101 that stores and outputs media content together with an acquired image and whole sound source, but it is not limited to this. The electronic device 101 can store media content related with just an image. For example, in a case where an image includes the Eiffel Tower, the electronic device 101 can associate and store the image, and music related with the Eiffel Tower. The electronic device 101 can store an image and related media content together, based at least on at least one of an image photographing time point, position information, etc. For example, in a case where a photographing time point is October 2015 and a location (or a place) of the electronic device 101 is New York, the electronic device 101 can associate and store an image, and music most popular in New York in October 2015.

A content providing method described herein can be used when using only sound source information without image acquisition. The content providing method described herein can also be used with a recorder application that uses sound source information, without having to acquire an image.

A content providing method described herein can be used with a ‘personal broadcasting’ application or service. The electronic device 101 can store a personal broadcasting application separately, and can provide a personal broadcasting service of the application. Music (e.g., background music) that a personal broadcasting provider utilizes for broadcasting can be separately provided to a viewer in a separable manner. The electronic device 101 can provide the viewer with link information enabling the viewer to listen to corresponding music for testing, or can provide a purchase link. The electronic device 101 can provide the above enumerated function even in case where the viewer records corresponding broadcasting and plays later.

In a case where sound is inputted from the external device through the microphone 288 electrically coupled to the electronic device 101, the electronic device 101 can output an image related with a sound source corresponding to the sound. For example, the electronic device 101 can search the memory 130 for an image associated with a sound source acquired from the external device. For example, the electronic device 101 can search a sound source of which a concordance rate with the sound source acquired from the external is greater than or equal to a threshold value. The electronic device 101 can identify an image associated with the searched sound, and can output the identified image.

In an electronic device including a memory and a processor, a method according to various embodiments of the present disclosure can include acquiring at least one image corresponding to one or more objects through a camera operatively coupled with the electronic device, acquiring a first sound source and a second sound source that are sensed in association with the acquiring operation through a microphone operatively coupled with the electronic device, using the processor to generate first sound source information corresponding to the first sound source and second sound source information corresponding to the second sound source, and storing the at least one image in the memory in a state in which the at least one image is associated with the first sound source information and the second sound source information.

The storing can include storing such that the first sound source and the second sound source are played independently of each other, and designating the first sound source information as a first attribute that shall be used at the playing, and the second sound source information as a second attribute that shall be used at the playing.

The generating can include identifying media content corresponding to the sound source, and the storing can include associating and storing information on the media content and the sound source information.

Identifying the media content can include performing the searching of the media content corresponding to the sound source for the electronic device or an external device, using the sound source, and determining the media content, based on the searching.

The method can include requesting the media content from the electronic device to an external device, and storing the media content that is acquired in response to the request.

The method can further include identifying another at least one image that is stored in association with third sound source information, and grouping the at least one image and the another at least one image, based on that the first sound source information or the second sound source information is related with the third sound source information.

The method can further include transmitting the first sound source information, the second sound source information, and the at least one image that is stored in the memory in a state of being associated with the first sound source information and the second sound source information, from the electronic device to an external device.

The method can further include, if the external device is a legacy device, transcoding or synthesizing the image and the first sound source information or the second sound source information, and transmitting information generated by the transcoding or synthesizing operation to the legacy device.

Acquiring the first sound source and the second sound source can include acquiring the first sound source and the second sound source using at least one of receive beamforming and a control of an amplification gain of the microphone.

In an electronic device including a memory storing first sound source information corresponding to a first sound source and second sound source information corresponding to a second sound source, a method according to various embodiments of the present disclosure can include checking a selection of at least one image, the first sound source and the second sound source being acquired at the same image photographing time point, displaying the at least one image through a display operatively coupled with the electronic device, and in association with the displaying, playing the first sound source using a first attribute and the second sound source using a second attribute, independently of each other, through a speaker operatively coupled with the electronic device.

The playing can include playing at least a part of media content as at least a part of the first sound source or the second sound source.

The playing can include requesting first media content or second media content from the electronic device to at least one external device, and receiving the first media content or the second media content from the at least one external device.

The playing can include including playing or non-playing, a sound quality, a sound volume, a timbre, a speed, a length or a combination of them, in the first attribute and the second attribute, and controlling the first attribute or the second attribute.

The playing can include displaying an interface corresponding to the content, and controlling the playing, based on an input inputted to the interface.

The method can further include associating and displaying the plurality of sound source information and the content.

Also, a structure of data used in the aforementioned embodiments described herein can be recorded in a non-transitory computer-readable recording medium. The non-transitory computer-readable recording medium can include a storage medium such as a magnetic storage medium (for example, a ROM, a floppy disc, a hard disc, etc.), an optical reading medium (for example, a Compact Disc-ROM (CD-ROM), a DVD, etc.).

A storage medium storing instructions that are set to allow at least one processor to perform at least one operation when being executed by the at least one processor, can include a computer-readable storage device recording a program for executing the at least one operation including acquiring at least one image corresponding to one or more objects through a camera operatively coupled with an electronic device including a memory and a processor, acquiring a first sound source and a second sound source that are sensed in association with the acquiring operation through a microphone operatively coupled with the electronic device, using the processor to generate first sound source information corresponding to the first sound source and second sound source information corresponding to the second sound source, and storing the at least one image in the memory in a state in which the at least one image is associated with the first sound source information and the second sound source information.

A method for providing content and an electronic device supporting the same according to various embodiments of the present disclosure can selectively provide, together with an image, content such as sound recorded at photographing, music included in the recorded sound, sound other than the music included in the recorded sound, etc.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. A method for use with an electronic device comprising a memory and a processor, the method comprising:
acquiring at least one image through a camera operatively coupled to the electronic device;
acquiring a first sound and a second sound, which are sensed when acquiring the at least one image, through a microphone operatively coupled to the electronic device;
generating first sound information corresponding to the first sound and second sound information corresponding to the second sound using the processor; and
associating the at least one image with the first sound information and the second sound information and storing the at least one image in the memory.

2. The method of claim 1, wherein storing the at least one image comprises:
storing the first sound and the second sound such that the first sound and the second sound are individually played; and
designating the first sound information as a first attribute to be used when playing the first sound, and the second sound information as a second attribute to be used when playing the second sound.

3. The method of claim 1, wherein generating the first sound information comprises identifying media content corresponding to one of the first sound and the second sound, and
storing comprises associating the media content with one of the first sound information and the second sound information.

4. The method of claim 3, wherein identifying the media content comprises:
performing searching of the media content corresponding to one of the first sound and the second sound for one of the electronic device and an external device, using one of the first sound and the second sound; and
determining the media content, based on the performed search.

5. The method of claim 3, further comprising:
requesting the media content from the electronic device to an external device; and
storing the media content that is acquired in response to the request for the media content.

6. The method of claim 1, further comprising:
identifying at least one other image that is stored in association with third sound information; and
grouping the at least one image and the at least one other image, based on whether one of the first sound information and the second sound information is related to the third sound information.

7. The method of claim 1, further comprising transmitting the first sound information, the second sound information, and the at least one image that is stored in the memory from the electronic device to an external device.

8. A method for use with an electronic device comprising a memory for storing first sound information corresponding to a first sound and second sound information corresponding to a second sound, the method comprising:
selecting at least one image, the first sound and the second sound being acquired at the same time as the at least one image is selected;
displaying the at least one image through a display operatively coupled to the electronic device; and
while the at least one image is being displayed, playing the first sound using a first attribute and the second sound using a second attribute, independently of each other, through a speaker operatively coupled to the electronic device.

9. The method of claim 8, wherein playing the first sound and the second sound comprises playing at least a part of media content as at least a part of one of the first sound or the second sound.

10. The method of claim 9, wherein playing the first sound and the second sound comprises:
requesting one of first media content and second media content from the electronic device to at least one external device; and
receiving one of the first media content and the second media content from the at least one external device.

11. The method of claim 10, wherein playing the first sound and the second sound comprises:
comprising one of playing and non-playing, a sound quality, a sound volume, a timbre, a speed, a length and a combination thereof, in the first attribute and the second attribute; and
controlling one of the first attribute and the second attribute.

12. The method of claim 10, wherein playing the first sound and the second sound comprises:
displaying an interface corresponding to one of the first media content and the second media content; and
controlling playing of one of the first sound and the second, based on an input inputted to the interface.

13. The method of claim 10, further comprising associating and displaying the first sound information and the second sound information with the first media content and the second media content.

14. An electronic device comprising:
a camera operatively coupled with the electronic device;
a microphone operatively coupled with the electronic device;
a memory;
a communication circuit; and
a processor configured to:
acquire at least one image s through the camera,
acquire a first sound and a second sound, which are sensed when the at least one image is acquired, through the microphone,
generate first sound information corresponding to the first sound and second sound information corresponding to the second sound, and
associate the at least one image with the first sound information and the second sound information and store the at least one image in the memory.

15. The electronic device of claim 14, wherein the processor is further configured to:
store the first sound and the second sound in the memory such that the first sound and the second sound are played independently of each other, and
designate the first sound information as a first attribute to be used when the first sound is played, and the second sound information as a second attribute when the second sound is played.

16. The electronic device of claim 14, wherein the processor is further configured to:
identify media content corresponding to one of the first sound and the second sound, and
associate the media content with one of the first sound information and the second sound information.

17. The electronic device of claim 16, wherein the processor is further configured to:
perform searching of the media content corresponding to one of the first sound and the second sound for one of the electronic device and an external device, using one of the first sound and the second sound, and
determine the media content, based on the searched media content.

18. The electronic device of claim 16, wherein the processor is further configured to:
control the communication circuit to request the media content from the electronic device to an external device, and
store the media content that is acquired in response to the request for the media content in the memory.

19. The electronic device of claim 14, wherein the processor is further configured to:
identify at least one other image that is stored in association with third sound information, and
group the at least one image and the at least one other image, based on whether one of the first sound information and the second sound information is related to the third sound information.

20. The electronic device of claim 14, wherein the processor is further configured to control the communication circuit to transmit the first sound information, the second sound information, and the at least one image that is stored in the memory from the electronic device to an external device.
